(19) United States
(12) Patent Application Publication
(10) Pub. No.: US 2024/0019841 A1
(43) Pub. Date: Jan. 18, 2024

(54) METHOD FOR PRODUCING A COMPONENT MANUFACTURED IN PART ADDITIVELY FOR A TECHNICAL DEVICE

(71) Applicant: Linde GmbH, Pullach (DE)

(72) Inventors: Herbert AIGNER, Pullach (DE); Karlmann KANZLER, Pullach (DE); Georg WIMMER, Pullach (DE); Christian Michael HERWERTH, Pullach (DE)

(21) Appl. No.: 18/247,585

(22) PCT Filed: Oct. 5, 2021
(86) PCT No.: PCT/EP2021/025386

§ 371 Date: Mar. 31, 2023

(30) Foreign Application Priority Data
Oct. 6, 2020 (EP) 20020462.6

(51) Int. Cl. G05B 19/4099; B33Y 80/00; B33Y 70/00; B33Y 10/00; B22F 10/40

(52) U.S. Cl. CPC G05B 19/4099; B33Y 80/00; B33Y 70/00; B33Y 10/00; B22F 10/40; G05B 2219/49023; B22F 10/28

(57) ABSTRACT

The present invention relates to a method for producing a component manufactured in part non-additively for a technical device, wherein a basic structure of the component with a predefined wall thickness is produced by means of a non-additive manufacturing method, wherein at least one region of the component is determined with the aid of an optimisation method, wherein in the at least one region, a supporting structure is applied to the basic structure by means of an additive manufacturing method.

The invention relates to a method for producing a component manufactured in part additively for a technical device and to a component manufactured in part additively for a technical device.

### PRIOR ART

Technical devices, such as machines, apparatuses or systems, or their individual components, are often exposed to high loads during operation. For instance, high loads can occur in components of a technical device through which fluid flows on account of the fluids guided through the component. For example, process media for carrying out heat exchange are supplied and discharged by headers of a heat exchanger, e.g., a brazed plate-fin heat exchanger. Such components, or the walls thereof, therefore often have to withstand high pressures, stresses and further loads. For example, the walls of pressure vessels can also be exposed to such high loads, for example in vessels for storing substances under positive or negative external or internal pressure.

For the dimensioning of such components, a position of the highest load on the component can be assumed, for example. The wall thickness of the component at this position is selected such that the wall can withstand the high loads at that location. Often, this position with the highest loads defines the wall thickness of the entire component.

DE 10 2018 213 416 A1 relates, for example, to the production of a component by means of a generative or additive manufacturing method. Specifically, DE 10 2018 213 416 A1 describes a method for planning tool paths along which a tool is to be moved relative to the component in the generative manufacturing method in order to deposit, along fiber paths, reinforcing fibers for reinforcing the component to be produced by means of the generative manufacturing method. For this purpose, component data characterizing a virtual model of the component to be produced are received. An input is received which characterizes at least one load acting on the virtual model at at least one location, and the location. Topology optimization is carried out on the basis of the input and on the basis of the component data, the fiber paths and the resulting tool paths being determined by the topology optimization in such a way that a load on the virtual model resulting from the load meets a predetermined optimization criterion.

According to DE 10 2018 213 416 A1, the entire component is thus manufactured completely by means of the generative or additive manufacturing method; this is associated with high costs and large time investment, however.

It is desirable to improve the production of components for technical devices.

### DISCLOSURE OF THE INVENTION

Against this background, the present invention proposes a method for producing a component manufactured in part additively for a technical device, and a component manufactured in part additively for a technical device, having the features of the independent claims. Each of the embodiments are the subject matter of the dependent claims and of the description below.

The invention is based on the knowledge of producing a simple basic structure of a component with a minimum required wall thickness by means of a non-additive manufacturing method, and specifically reinforcing or stiffening said basic structure at certain positions that are exposed to increased mechanical stresses by applying material by means of additive manufacturing. These regions or positions of the basic structure to be reinforced are determined by an optimization method or an optimization algorithm.

In the context of the present method, a basic structure of the component is manufactured with a predefined wall thickness by means of a non-additive manufacturing method. At least one region of the component, expediently at least one region to be reinforced, is determined or identified or located by means of an optimization method. In this at least one region, a supporting structure is applied to the basic structure by means of an additive manufacturing method.

The basic structure expediently represents a basic volume or a first material volume. The supporting structure represents in particular an additional volume or a second material volume. The entire component or a total volume of the component is thus formed by the basic structure or the basic volume and the supporting structure applied thereto or the additional volume applied thereto.

The basic structure with the predefined wall thickness can be manufactured, for example, by means of a non-additive manufacturing method such as conventional primary forming, for example casting, or conventional forming, for example bending. For example, in the course of the method, an entire wall defining the component can be produced as a single piece. Likewise, individual partial walls can also be produced separately, e.g., by means of such non-additive manufacturing methods as conventional primary forming or conventional forming, and combined to form the overall wall of the component, e.g., by means of a joining method, for example a welding method.

Non-additive manufacturing methods in the present context should be understood, for example, as a manufacturing method according to the standard DIN 8580, which is not counted as additive manufacturing. Further examples of non-additive manufacturing methods are, for example, conventional primary forming methods such as casting, e.g., gravity casting, pressure casting, low pressure casting, centrifugal casting, continuous casting, injection molding, etc., or such as pressing, e.g., transfer molding, extrusion, etc. Further examples of non-additive manufacturing methods include, for example, conventional forming methods such as bending, rolling, open-die forging, closed-die forging, extrusion, deep drawing, etc. Furthermore, for non-additive manufacturing of the basic structure, it is possible, for example, to use conventional joining methods, e.g., welding, soldering, gluing, etc., or for example, conventional separation methods, e.g., machining, shearing, flame cutting, spark eroding, etc.

In particular, the wall thickness of the basic structure can be predefined as the smallest possible, in particular minimum, wall thickness, which is expediently designed for a low load acting on the component or which at least requires the basic structure in order to be able to withstand the acting loads. The basic structure is then specifically reinforced by the supporting structure at locations with higher loads, so that the component can also withstand the higher loads acting at these locations. The supporting structure can thus be applied in a targeted manner to particularly stressed positions of the component and the component can be individually adapted to the load case in question.

The basic structure and the supporting structure can in principle be manufactured from the same material or expediently also from different materials. For example, in the case of different materials at particular regions, specific material properties can be utilized in a targeted manner.

The additive manufacturing method makes it possible to apply the supporting structure precisely and thus produce precise local reinforcements of the basic structure. Additive manufacturing is a production method in which a three-dimensional object or a three-dimensional structure is produced by consecutively adding a material layer by layer. One after the other, a new material layer is applied, solidified and firmly bonded to the underlying layers, for example by means of a laser, electron beam or electric arc.

In the context of the present method, the regions or locations at which the basic structure is to be reinforced by the supporting structure are determined or identified or located by means of the optimization method or a corresponding optimization algorithm. Generally speaking, optimization methods or optimization are generally understood to be analytical or numerical calculation methods for discovering optimized, in particular minimized or maximized, parameters of a complex system.

For this purpose, an optimization problem can in particular be formulated, in which a solution space Ω, i.e., a quantity of possible solutions or variables \vec{x}, and a target function ƒ are specified. To solve this optimization problem, a set of values of the variables or solutions \vec{x}∈Ω is sought, so that ƒ(\vec{x}) fulfills a predefined criterion, for example maximum or minimum. Furthermore, constraints or secondary conditions can also be predefined, with permissible solutions \vec{x} having to meet these predefined constraints. In the present case, to solve the optimization problem, for example, a target function can be defined such that the total wall thickness of the component is minimized as far as possible.

The optimization method is particularly expediently carried out on the basis of a numerical solution, in particular by a finite element analysis (FE analysis). In this case, the component is divided into a finite number of subsections, which are referred to as finite elements. A so-called pseudo density is assigned to each finite element associated with an optimization space. The stiffness of the structure is primarily influenced by this pseudo density, and elements of which the pseudo density is below a predefined threshold value are iteratively removed.

In this way, the component can be divided into a plurality of individual regions as part of the optimization method, and it can be determined individually for these regions whether material is to be applied in each of these regions by means of additive manufacturing. For example, a minimized total wall thickness can be determined in each of these individual regions by solving the optimization problem. According to the result of the optimization method, the corresponding supporting structure is applied individually in each of the correspondingly determined regions. The total wall thickness of the component, i.e., the sum of the predefined wall thickness of the basic structure and the supporting structure, is therefore in particular not constant and can vary over the entire component.

Conventionally, a constant wall thickness which is oriented to the wall thickness of the position with the highest load is often specified for a component. Often, the component can have a higher wall thickness at locations with a lower load than is actually required, which is associated with high material consumption and thus with unnecessary costs.

Particularly expediently, in the context of the present method, instead of a component with a constant wall thickness, a component with an individual, specially adapted wall thickness profile can be produced, in particular with an individual volume distribution or an individual profile of different materials. Such a non-constant wall thickness profile or a non-uniform distribution of different materials by means of conventional, non-additive manufacturing methods such as conventional primary forming or conventional forming can often prove to be very complex.

The present method now provides a possibility for producing a component manufactured in part additively, the basic structure being manufactured non-additively and the supporting structure being manufactured additively. The basic structure can be manufactured inexpensively and with material savings by means of the non-additive manufacturing method. The use of the additive manufacturing method can be reduced, such that costs and material can also be saved in this regard. The component can be manufactured cost-effectively, with material savings and reduced weight and can be optimally adapted to the subsequent application and its area of use.

The present invention therefore proposes an improved method for manufacturing components for technical devices, which is associated with low costs, low material expenditure and little time required.

In contrast to the present method, according to DE 10 2018 213 416 A1, which is mentioned at the outset, a generative or additive manufacturing method requires a component to be manufactured in its entirety. According to DE 10 2018 213 416 A1, a component can be reinforced by means of reinforcing fibers. However, not only these reinforcing fibers but the entire component are manufactured additively, and this is associated with high costs and large time investment. Within the scope of DE 10 2018 213 416 A1, it is therefore not possible to produce a component only in part additively. By means of the topology optimization in said document, it is not possible to determine regions on a non-additively manufactured basic structure in which regions material is additionally applied to the basic structure as a supporting structure by means of additive manufacturing. According to DE 10 2018 213 416 A1, all regions in which material is applied by means of additive manufacturing are determined in order to produce the component. In contrast, the present invention enables improved, more cost-effective and more economical production of components.

Advantageously, the predefined wall thickness of the basic structure is predefined on the basis of a minimum required wall thickness or as this minimum required wall thickness in order to be able to withstand a maximum design pressure. Design pressure, or also calculation pressure, is to be understood in particular to mean a pressure which acts on the wall of the component from the inside or outside during regular operation of the component. The wall thickness of the basic structure is expediently designed in such a way that the design pressure to be expected during subsequent operation of the component can be withstood. Particularly expediently, the minimum required wall thickness is determined according to the standards DIN EN 13445-3 Chapter 7 or ASME VIII-1 Subsections A UG-27 and UG-28, which define the design of the wall thickness according to permissible design or calculation pressure. For example, the minimum required wall thickness according to Barlow's formula can be determined as described in the standards DIN EN 13445-3 Chapter 7 and ASME VIII-1 Subsections A UG-27 and UG-28.

Alternatively or additionally, the predefined wall thickness of the basic structure is particularly expediently predefined on the basis of the minimum required wall thickness or as the minimum required wall thickness in order to be able to withstand loads at regions far away from disturbance points. Disturbance points are to be understood to mean, in particular, global disturbance points or external disturbance sources which, when the component is in operation, may exert loads on the component in addition to the design or internal pressure. Such disturbance points can be of different nature and, for example, include specific mechanical disturbance points in the component itself, such as openings, bends, connections to other components, etc., or also external temperature or pressure fluctuations as well as external weather or climate conditions such as earthquakes, gusts of wind, etc. Regions far away from global disturbance points are defined in particular in the standard DIN EN 13445-3 Annex C, in particular as regions in which stress, pressure and mechanical loads are below predefined limit values.

Expediently, the minimum required wall thickness and thus the wall thickness of the basic structure are thus predefined in such a way as to be able to withstand the design pressure to be expected during subsequent regular operation without the additional supporting structure at regions far away from disturbance points. The supporting structure is thus expediently applied by means of additive manufacturing to the basic structure at regions of the component that are subjected to loads due to disturbance sources or disturbance points. These may be, for example, mechanical stresses due to openings, bends, connections, etc.

In particular, the predefined wall thickness of the basic structure corresponds to this minimum or minimum required wall thickness. The basic structure can thus be manufactured in particular with the lowest possible material consumption. Furthermore, the wall thickness can expediently also be somewhat thicker than the minimum required wall thickness and thus in particular between the minimum or minimum required wall thickness and a maximum or maximum required wall thickness. For example, the predefined wall thickness can exceed the minimum or minimum required wall thickness by a maximum of 50%, in particular by a maximum of 25%, further in particular by a maximum of 15%, more in particular by a maximum of 10%, further in particular by a maximum of 5%. The basic structure can thus be manufactured non-additively in a conventional manner with a smallest wall thickness or even the smallest possible wall thickness. The supporting structure can be applied in a targeted manner by additive manufacturing at specific locations of higher load, so that the component can reliably withstand all loads during subsequent operation.

Advantageously, an optimized wall thickness is determined for the at least one region in the course of the optimization method. Expediently, a maximum total wall thickness for the component that is sufficiently large for the component to be able to withstand the highest load, for example, is predefined. For the individual regions of the component, it is expediently assessed whether the total wall thickness can be reduced, and that value with which the component can withstand the loads acting on the particular region is determined as an optimized wall thickness. In regions with high or highest load, the maximum total wall thickness is in particular hardly reduced or not reduced. If necessary, or in the case of very high load, the maximum total wall thickness can also be increased further. In regions with low load, the total wall thickness can be reduced or minimized. Alternatively, a minimum total wall thickness can also be assumed and a determination can expediently be made in the course of the optimization method as to at which locations the total wall thickness is to be increased on the basis of the loads acting there. This minimum total wall thickness can correspond, for example, to the predefined wall thickness of the basic structure. In particular, the optimized wall thickness for the individual regions in each case represents the smallest possible wall thickness at which predefined structural properties of the component can nevertheless be achieved.

Advantageously, depending on the optimized wall thickness in the at least one specific region, the supporting structure is applied to the non-additively manufactured basic structure by means of the additive manufacturing method. In particular, a wall thickness of the supporting structure in the individual regions is determined in each case on the basis of a difference between the optimized wall thickness and the predefined wall thickness. A thickness or height of a layer applied by the additive manufacturing method to the non-additively manufactured basic structure is expediently predefined by this difference.

Preferably, in the course of the optimization method, a locally required wall thickness of the component, in particular a minimization of the wall thickness or the total wall thickness of the component, is adapted on the basis of loads that act on the component during operation. The loads acting on the component can be formulated accordingly in the optimization problem. The correspondingly minimized total wall thickness can particularly expediently be determined as an optimized wall thickness. Expediently, the corresponding supporting structure is applied to the basic structure in the respective regions, so that the sum of the predefined wall thicknesses of the basic structure and the supporting structure corresponds to the optimized or minimized total wall thickness determined for the region in question.

Preferably, a total wall thickness in the at least one region, composed of the predefined wall thickness of the basic structure and a thickness of the supporting structure, is determined in the course of the optimization method in order to be able to withstand a load acting on the component in the at least one region during operation. In this way, the thickness of the supporting structure and, furthermore, the total wall thickness, can be determined particularly expediently on the basis of the predefined wall thickness of the basic structure and further on the basis of the loads acting on the component during subsequent operation. Expediently, a best possible combination of non-additive and additive manufacturing can thus be made possible.

Preferably, in the course of the optimization method, a stiffness of the component and/or a maximum occurring stress in the component and/or a geometric constraint are taken into account as a constraint. Preferably, the maximum occurring stress is limited as part of the optimization method. Expediently, the stiffness, the moment of inertia or various geometric aspects can also be taken into account as the constraint, for example. For example, it is specified as a constraint for the optimization method that a predefined minimum stiffness of the component must be met. In particular, in the course of the optimization method, the minimization of the total wall thickness or the determination of the optimized wall thickness is carried out so that the predefined constraint is not violated and so that the component has at least the predefined stiffness or does not exceed a maximum stress.

According to a preferred embodiment, topology optimization is carried out in the course of the optimization method. Topology optimization is understood in particular to mean computer-based calculation methods for determining a structure or topology of a component that is as favorable as possible. For example, a geometric body can be predefined as a maximum installation space that the component is to occupy at the maximum. The maximum installation space can be subdivided into individual elements or regions and, as a result of the topology optimization, a determination can expediently be made as to which individual elements or regions of the installation space are to be occupied with material. For example, a determination can be made as to which elements are required for conformity with the set constraints. The other elements are iteratively eliminated. For example, in the course of what is known as material topology optimization, the geometry of the component can be described in a design space. A density or pseudo density can be assigned to each element in the design space. The individual densities can each assume values between 0 and 100%, for example, and the individual elements can be obtained or eliminated on the basis of a limit value.

It is understood that the optimization method is not intended to be limited to topology optimization with pseudo densities, but rather that further optimization methods can also expediently be used with other approaches.

Alternatively or additionally, a material optimization of the component is preferably carried out in the course of the optimization method. To solve the optimization problem, in this case, for example, the target function can be defined in such a way that the material required for the wall of the component is minimized.

Alternatively or additionally, a load optimization and/or a stress optimization is preferably carried out in the course of the optimization method. The component can, for example, be optimally adapted to the loads or stresses that occur. Alternatively or additionally, a geometry optimization is preferably carried out in the course of the optimization method. For example, a geometry or shape of the component can thus be adapted on the basis of predefined constraints.

Alternatively or additionally, a flow optimization can preferably be carried out in the course of the optimization method. In particular, the component can be specifically adapted to the fluidic requirements in order, for example, to enable uniform through-flow without different or significantly different flow rates or to prevent, for example, the occurrence of regions of slow or no through-flow, i.e., “dead spaces,” which could lead to a segregation of fluids.

Advantageously, the optimization method is carried out on the basis of a simulation of the component, in particular a numerical simulation, more particularly a simulation of the technical device comprising the component. In particular, a static or dynamic simulation can be carried out, for example a thermo-mechanical strength simulation. By means of the simulation, the component or the entire technical device together with the component can be reproduced theoretically. The behavior of the component during regular operation and the stresses, loads, etc. acting on the component can be simulated. In particular, the total wall thickness of the component can be changed in the course of the simulation in order to examine the behavior of the component with different wall thicknesses.

According to a particularly advantageous embodiment, the simulation of the component, in particular the technical device, is carried out using a finite element method (FEM). The finite element method is a numerical method based on the numerical solution of a complex system of partial differential equations. The component or the device is divided into a finite number of sub-regions of simple shape, i.e., into finite elements of which the physical or thermo-hydraulic behavior can be calculated on the basis of their simple geometry. In each of the finite elements, the partial differential equations are replaced by simple differential equations or by algebraic equations. The system of equations thus obtained is solved in order to obtain an approximate solution of the partial differential equations. During the transition from one element into the adjacent element, the physical behavior of the entire body is simulated by predetermined continuity conditions. Such a finite element simulation is particularly advantageous for carrying out an optimization method. For example, in the context of the present method, for each of the individual finite elements it can be examined whether they are to be filled with a corresponding material as part of the basic structure or supporting structure.

According to a particularly preferred embodiment, the supporting structure or the additional volume is applied to the basic structure by means of what is known as wire and arc additive manufacturing (WAAM). In the course of this WAAM, individual layers are produced by means of a consumable wire and an arc. For this purpose, welding torches, for example for gas-shielded metal-arc welding, can be used, in which an arc burns between the welding torch and the component to be produced. A corresponding material is continuously fed in, e.g., in the form of a wire or strip, and melted by the arc. This causes molten droplets to form, which transition onto the workpiece to be produced and firmly connect thereto. The particular material can be supplied, for example, as a consumable wire electrode of the welding torch, with the arc burning between this wire electrode and the component. It is also conceivable to supply the material in the form of an additional wire which is melted by the arc of the welding torch.

Alternatively or additionally, further additive manufacturing methods can be used, in the course of which the material of the supporting structure or of the additional volume is applied, for example in powder form or in the form of wires or strips, and is applied by means of a laser and/or electron beam. In this way, the material can be subjected, for example, to a sintering or melting process in order to be solidified. After producing a layer, the next layer can be produced in an analogous manner. Additive manufacturing methods of this type include, for example, selective laser sintering (SLS), selective laser melting (SLM), electron beam melting (EBM), stereolithography (SL), fused deposition modeling (FDM) and fused filament fabrication (FFF).

Alternatively or additionally, additive manufacturing methods can also be used for which no laser beam, electron beam or arc is used. Preferably, the supporting structure can be applied to the basic structure means of by cold spraying (CS) or gas dynamic cold spraying. In the course of this process, the material is applied, for example, in powder form at high speed. For this purpose, a process gas, such as nitrogen or helium, which is heated to a few hundred degrees, can be accelerated, for example by expansion, to supersonic speed. The powder particles of the material can be injected into the gas jet so that they are accelerated to high speed and form a firmly adhering layer upon impact with the basic structure.

Preferably, the basic structure or the basic volume and the supporting structure or the additional volume are manufactured from the same material, for example from aluminum or an aluminum alloy. Furthermore, the basic structure and supporting structure can preferably also be manufactured from different materials. The materials for the basic structure and supporting structure can each be selected, for example, on the basis of their specific material properties and/or on the basis of specific component requirements or on the basis of the specific loads acting on the component.

Preferably, the basic structure or the basic volume and the supporting structure or the additional volume are manufactured from materials of similar type or materials of dissimilar type, preferably from different aluminum materials or different aluminum alloys. Materials “of similar type” or “of the same type” are to be understood in particular to be materials which have an identical or comparable structure and/or an identical or comparable thermal expansion, which, in contrast, is not the case with materials “of dissimilar type” or “of different type”. Materials of similar type are, for example, different carbon steels. In contrast, carbon steel and stainless steel are, for example, of dissimilar type due to the different material structure (structure and thermal expansion). The term “materials of similar type” can also be understood to mean various aluminum alloys which, due to the diversity of possible alloys, lead to large differences in mechanical and thermal characteristics. An example of materials of dissimilar type may be the connection of an aluminum material to a (stainless) steel material which is “not tolerated” in many respects. Expediently, it is therefore possible to use specifically materials of the same or different type with other properties to construct the basic structure and the supporting structure.

Particularly preferably, the material of the basic structure is more resistant or less wear-sensitive than the material of the supporting structure, in particular relative to mercury. Alternatively or additionally, the material of the supporting structure preferably has a higher strength than the material of the basic structure. If, for example, only the basic structure comes into contact with this material during regular operation of the component, the component therefore has a high resistance. By contrast, a higher-strength material can be selected for the supporting structure, which is then expediently not in contact with this material, in order to achieve a high strength of the component. Particularly expediently, the basic structure is preformed, for example from an aluminum alloy with a low magnesium content, which imparts high mercury insensitivity on the component, and the supporting structure is manufactured from a higher-strength and better weldable aluminum alloy, so that an insensitive component with adapted strength or stiffness can be produced. If the component is provided, for example, for storing or transporting Hg-containing media, the risk of Hg-induced stress corrosion cracking can thus be reduced. For this purpose, the material of the basic structure can be, for example, an aluminum alloy, e.g., an AlMg or AlMgMn alloy, with an Mg content of less than 2%. The material of the supporting structure can be, for example, an aluminum alloy with an Mg content of more than 2%.

The present invention is suitable for a number of different fields of application and for the production of components for various technical devices used in process, regulation and/or control engineering. In the present context, a technical device is to be understood in particular as a unit or a system of different units for carrying out a technical process, in particular a process, regulation and/or control engineering process. The technical device can advantageously be designed as a machine, i.e., in particular as a device for energy or force conversion, and/or as an apparatus, i.e., in particular a device for substance or matter conversion. Furthermore, the technical device can also be designed in particular as a system, i.e., in particular as a system of a plurality of components, which may each be machines and/or apparatuses, for example.

According to a particularly advantageous embodiment, the component is a component, in particular a component through which fluid flows or can flow, for a technical device.

Preferably, the component is a component for a pressure vessel or is itself a pressure vessel. Such a pressure vessel can be provided in particular for storing a substance under positive or negative internal or external pressure. Pressure vessels can be exposed to high alternating pressure loads. Such a pressure vessel can comprise, for example, a pressure vessel wall, in particular an inner and outer pressure vessel wall, a pressure vessel lid, a pressure vessel base and/or pipelines. Individual or a plurality of such elements can be produced particularly expediently according to the present method.

Preferably, the component is a component through which fluid flows for a heat exchanger, for example for a straight-pipe heat exchanger, a plate heat exchanger or a lamella plate heat exchanger or plate-fin heat exchanger (PFHE), further for example for a brazed plate-fin heat exchanger made of aluminum (PFHE) (designations according to the German and English edition of ISO 15547-2:3005). Plate heat exchangers of this type have a plurality of stacked partition plates and lamellae, as well as cover plates, edge strips or side bars, distributors or headers. Furthermore, pipe sections or pipelines for supplying and discharging individual media are provided. Such elements can be exposed to high loads during operation of the heat exchanger, for example high temperatures or temperature differences as well as high pressures and mechanical stresses, and are therefore particularly suitable for being produced according to the present method.

However, the present invention is not limited to components through which fluid flows and technical devices, but is advantageously suitable for a large number of different structural components and technical fields of application, for example for lightweight construction, aircraft construction and vehicle construction etc.

In addition to the method for producing a component, the present invention further relates to a component for a technical device which is produced according to the present method. Embodiments of this component according to the invention result analogously from the above description of the method according to the invention.

Further advantages and embodiments of the invention arise from the description and the accompanying drawings.

It is to be understood that the features mentioned above and those still to be explained below may be used not only in the particular combination specified, but also in other combinations or by themselves, without departing from the scope of the present invention.

The invention is schematically represented in the drawings using exemplary embodiments and will be described in detail below with reference to the drawings.

### DESCRIPTION OF FIGURES

FIG. 1 schematically shows a heat exchanger in simplified isometric representation, in which individual components of the heat exchanger are manufactured according to a preferred embodiment of a method according to the invention.

FIG. 2 schematically shows a preferred embodiment of a method according to the invention as a block diagram.

FIG. 3 schematically shows a header of a heat exchanger according to the prior art.

FIG. 4 schematically shows a header of a heat exchanger which is manufactured according to a preferred embodiment of a method according to the invention.

### DETAILED DESCRIPTION OF THE DRAWING

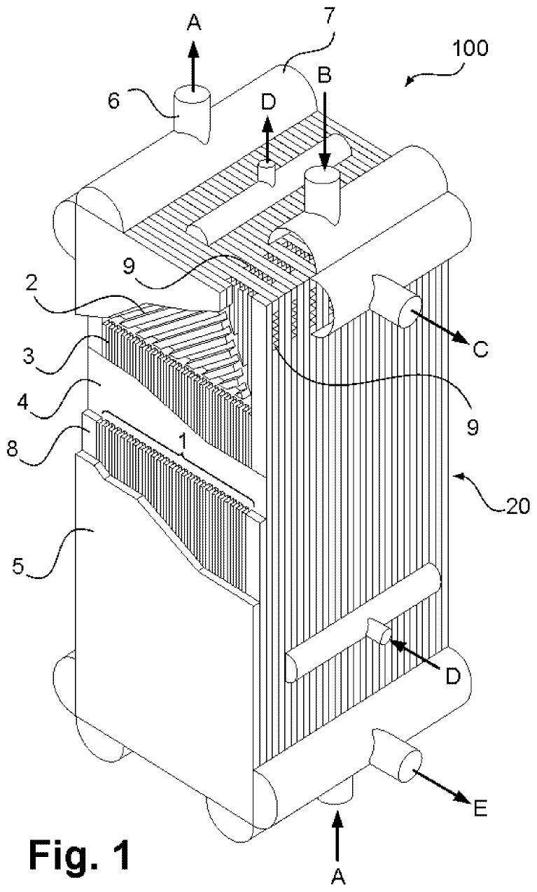

FIG. 1 is a schematic representation of a heat exchanger, which is denoted by 100. The heat exchanger represents a technical device, wherein individual elements or components of the heat exchanger 100, in particular through which fluid flows, in particular the header 7 thereof, are manufactured in a particularly advantageous manner according to a preferred embodiment of a method according to the invention.

The heat exchanger 100 shown in FIG. 1 is a brazed plate-fin heat exchanger made of aluminum (PFHE) (designations according to the German and English edition of ISO 15547-2:3005), as can be used in a large number of systems at very different pressures and temperatures. For example, they are used in cryogenic air separation, in the liquefaction of natural gas and in ethylene production plants. It is understood that “aluminum” can also denote an aluminum alloy.

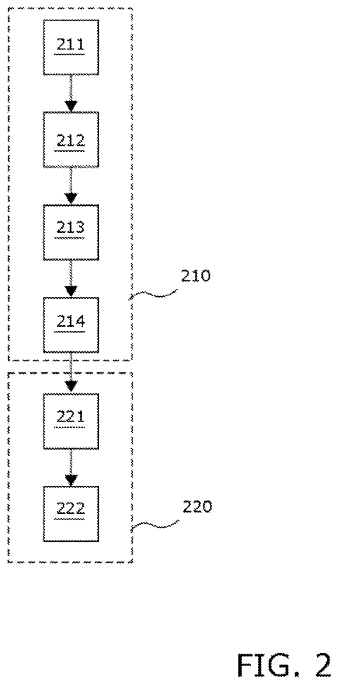

Brazed plate-fin heat exchangers made of aluminum are shown and described in FIG. 2 of the above-mentioned ISO 15547-2:3005, as well as on page 5 of the ALPEMA publication “The Standards of the Brazed Aluminum Plate-Fine Heat Exchanger Manufacturers' Association”, 3rd edition, 2010. The present FIG. 1 substantially corresponds to the illustrations of the aforementioned ISO standard and will be explained below.

The plate heat exchanger 100 shown partly open in FIG. 1 is used for the heat exchange of five different process media A to E in the example shown. For heat exchange between the process media A to E, the plate heat exchanger 100 comprises a plurality of separating sheets 4 arranged in parallel with one another (in the previously mentioned publications, to which the subsequent references in brackets also refer, these are called “parting sheets”), between which heat exchange passages 1 defined by structural sheets with lamellae 3 (“fins”) are formed, in each case for one of the process media A to E, and which can thereby come into heat exchange with one another.

The structural sheets with the lamellae 3 are typically folded or corrugated, and flow channels are formed by each of the folds or corrugations, as also shown in FIG. 1 of the ISO 15547-2:3005. The provision of the structural sheets with lamellae 3 offers the advantage of improved heat transfer, more targeted fluid guidance and an increase in the mechanical (tensile) strength in comparison with plate heat exchangers without lamellae. In the heat exchange passages 1, the process media A to E flow, in particular separated by the separating sheets 4, but can optionally pass through the latter with lamellae 3 in the case of perforated structural sheets.

The individual passages 1 or the structural sheets with the lamellae 3 are surrounded on each side by what are known as side bars 8, which leave space free for feed and removal openings 9, however. The side bars 8 hold the separating sheets 4 at a distance and ensure mechanical reinforcement of the pressure chamber. Cover sheets 5 (“cap sheets”), which are in particular reinforced, are arranged in parallel with the separating sheets 4 and are used in particular to close off at least two sides.

By means of what are known as headers 7, which are provided with nozzles 6 (“nozzles”), the process media A to E are supplied and discharged via feed and removal openings 9. In the inlet region of the passages 1, there are further structural sheets with what are known as distributor lamellae 2 (“distributor fins”), which ensure uniform distribution over the entire width of the passages 1. As seen in the direction of flow, further structural sheets with distributor lamellae 2 can be located at the end of the passage 1, and lead the process media A to E from the passages 1 into the header 7, where they are collected and withdrawn via the corresponding nozzles 6.

A heat exchanger block 20, which is cuboid in this case, is formed overall by the structural sheets with the lamellae 3, the further structural sheets with the distributor lamellae 2, the side bars 8, the separating sheets 4 and the cover sheets 5, and the “heat exchanger block” being understood here to be the stated elements without the headers 7 and nozzles 6 in an interconnected state. As not illustrated in FIG. 1, the plate heat exchanger 100 can, in particular for manufacturing reasons, be formed from a plurality of corresponding cuboidal and interconnected heat exchanger blocks 20.

Corresponding plate heat exchangers 100 are brazed from aluminum. The individual passages 1, comprising the structural sheets with the lamellae 3, the further structural sheets with the distributor lamellae 2, the cover sheets 5 and the side bars 8, are in this case each provided with solder, stacked one on top of the other or arranged accordingly, and heated in an oven. The header 7 and the nozzles 6 are welded onto the heat exchanger block 20 produced in this way.

The headers 7 are produced in the conventional way, for example using semi-cylindrical extruded profiles which are brought to the required length and are then welded onto the heat exchanger block 20. In this case, the header 7 is often manufactured with a constant wall thickness, and this wall thickness is oriented to the position of the highest utilization.

In contrast to this, the present method allows the header 7 to be produced cost-effectively and with material savings, with a varying wall thickness that is specifically adapted to the individual load case in question, as will be explained below with reference to FIG. 2.

FIG. 2 shows schematically a preferred embodiment of a method according to the invention as a block diagram.

In the following, it will be explained by way of example how a component in the form of a header for a technical device in the form of a heat exchanger is produced in part additively in the course of the present method. However, it is understood that the present invention is not to be limited to headers and heat exchangers, but is advantageously suitable for a large number of different structural components and technical fields of application, for example for lightweight construction, aircraft construction and vehicle construction etc.

In the course of the production process, a planning or simulation phase 210 is first carried out before the component or the header is actually manufactured in the course of a manufacturing phase 220.

In step 211, a simulation of the header to be produced, or further of the entire heat exchanger comprising the header, is created by means of a finite element method (FEM). The header is divided into a finite number of sub-regions, or finite elements, of simple shape, of which the physical or thermo-hydraulic behavior can be calculated on the basis of their simple geometry. During the transition from one element into the adjacent element, the physical behavior of the entire header is simulated by predetermined continuity conditions.

In particular, mechanical or thermo-hydraulic loads acting on the header in the course of the FEM simulation during operation of the heat exchanger are taken into account, in particular pressures, stresses etc. Expediently, the individual finite elements of the FEM simulation each represent regions of the wall of the header.

In step 212, a minimum required total wall thickness and a maximum required total wall thickness are specified, which the wall of the header should have at least or at most, respectively. For example, the total wall thickness can also be specified by means of a geometric body as a maximum installation space that the header is to occupy at the maximum.

The minimum required wall thickness is specified, for example, in such a way as to be able to withstand a maximum design pressure, in particular a design or calculation pressure that acts on the wall of the header from the inside or outside during subsequent regular operation.

Alternatively or additionally, the minimum required wall thickness can be specified in such a way that loads at regions far away from disturbance points can be withstood, in particular global disturbance points or external disturbance sources which, when the header is in operation, may exert loads on the header in addition to the design or internal pressure.

For example, the minimum required wall thickness can be specified according to the standards DIN EN 13445-3 Chapter 7 or ASME VIII-1 Subsections A UG-27 and UG-28, which define the design of the wall thickness of components according to permissible design or calculation pressure.

In step 213, an optimization method is carried out on the basis of the FEM simulation, for example a topology optimization. For example, in the course of the optimization method, the total wall thickness of the header is minimized, a constraint being that a predefined minimum stiffness of the component be met.

In step 214, it is determined as a result of the optimization method which of the individual finite elements are to be filled with material, so that the component has a minimized or optimized total wall thickness. For example, a first number of finite elements are to be filled, so that the header reaches the predefined minimum total wall thickness. In particular, these elements or regions relate to a basic structure of the header. Furthermore, for example, an additional, second number of finite elements or regions are to be filled, so that the header can withstand higher loads occurring at these locations. These regions relate in particular to a supporting structure which reinforces the basic structure in a targeted manner.

On the basis of these results, the header is manufactured in the course of the manufacturing phase 220. In step 221, an appropriate basic structure or a basic volume is first produced by manufacturing a wall of the header with a predefined wall thickness by means of a non-additive manufacturing method. For example, the predefined wall thickness of the above-explained minimum total wall thickness specified in step 212 may be adequate. For example, the basic structure can be produced by casting or bending.

In certain regions, the basic structure is reinforced by a corresponding supporting structure or an additional volume. These regions are determined in particular by the second number of finite elements explained above. For this purpose, in step 222, a quantity of an additional material is applied to the non-additively manufactured wall or the basic structure at these specific regions by means of an additive manufacturing method.

Particularly preferably, a particular material is applied by means of wire and arc additive manufacturing in order to produce the supporting structure. Individual layers are produced by means of a consumable wire and an arc, with the material being continuously fed in, e.g., in the form of a wire or strip, and being melted by the arc. By means of such a WAAM method, the additional, reinforcing or stiffening volume and thus the supporting structure can be applied precisely to the basic structure.

The present method thus makes it possible to selectively apply material to particularly stressed positions on the header by means of the WAAM method. In this way, a simple basic structure corresponding to the minimum required wall thickness can be prefabricated and stiffened or reinforced in a targeted manner and thereby adapted to the individual load case in question.

Furthermore, the present method enables a targeted use of materials of the same type with other properties for the construction of the basic structure and the supporting structure. For example, the basic structure can be preformed from an aluminum alloy with a low magnesium content. This imparts mercury insensitivity on the header. The supporting structure is produced, for example, from higher-strength and better weldable aluminum alloys. In this way, an insensitive header with adapted strength or stiffness can be produced.

For example, the first material can be an aluminum alloy, e.g., an AlMg or AlMgMn alloy, with an Mg content of less than 2%, and the second material can be, e.g., an aluminum alloy with an Mg content of more than 2%.

Furthermore, it is also expediently conceivable to manufacture the basic structure and the supporting structure from materials of dissimilar type or, for example, from the same material.

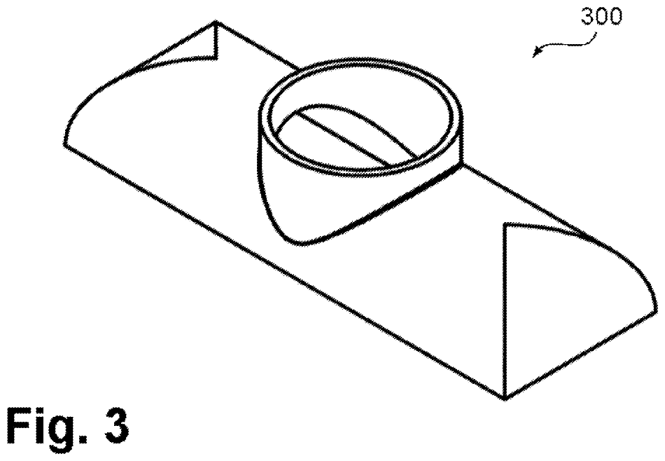

FIG. 3 is a schematic representation of a header 300 of a heat exchanger which is produced according to the prior art. For example, the header 300 has a constant wall thickness and is produced continuously from the same material.

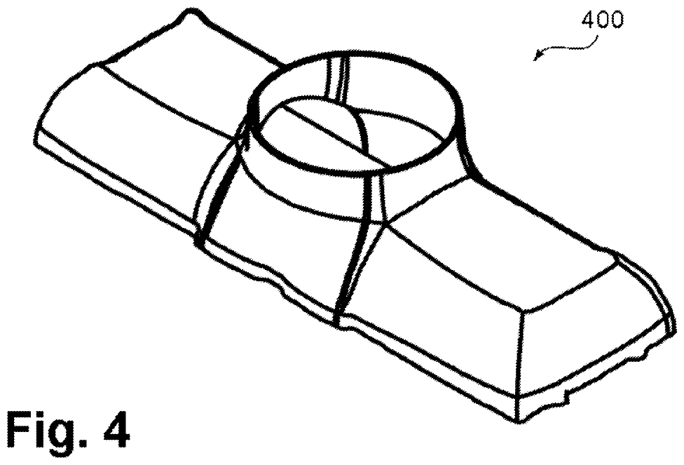

In comparison thereto, FIG. 4 schematically shows a header 400 which is manufactured in part additively according to a preferred embodiment of a method according to the invention. As can be seen, the header 400 does not have a constant wall thickness, but has individual wall thicknesses in each of the different regions or finite elements.

The header 400 according to the present method can therefore be produced more cost-effectively and with less material expenditure than the conventional header 300 according to the prior art.

1. A method for producing a component manufactured in part additively for a technical device,
wherein a basic structure of the component is manufactured with a predefined wall thickness by means of a non-additive manufacturing method,
wherein at least one region of the component is determined by means of an optimization method,
wherein, in the at least one region, a supporting structure is applied to the basic structure by means of an additive manufacturing method.

2. The method according to claim 1, wherein the predefined wall thickness of the basic structure is predefined on the basis of a minimum required wall thickness or as this minimum required wall thickness in order to be able to withstand a maximum design pressure.

3. The method according to claim 1, wherein, in the course of the optimization method, an optimized wall thickness is determined for the at least one region, and wherein the supporting structure is applied to the basic structure in the at least one region on the basis of the optimized wall thickness by means of the additive manufacturing method.

4. The method according to claim 1, wherein, in the course of the optimization method, an adaptation of a locally required wall thickness of the component is carried out on the basis of loads acting on the component during operation.

5. The method according to claim 1, wherein a total wall thickness in the at least one region, composed of the predefined wall thickness of the basic structure and a thickness of the supporting structure, is determined in the course of the optimization method in order to be able to withstand a load acting on the component in the at least one region during operation.

6. The method according to claim 1, wherein, in the course of the optimization method, a stiffness of the component and/or a maximum occurring stress in the component and/or a geometric constraint are taken into account as a constraint.

7. The method according to claim 1, wherein, in the course of the optimization method, a topology optimization and/or a material optimization and/or a load optimization and/or a stress optimization and/or a flow optimization and/or a geometry optimization of the component is carried out.

8. The method according to claim 1, wherein the optimization method is carried out on the basis of a simulation of the component, in particular the technical device comprising the component, in particular by means of a finite element method.

9. The method according to claim 1, wherein the supporting structure is applied to the basic structure in the at least one determined region by means of arc wire surfacing welding and/or selective laser sintering and/or selective laser melting and/or electron beam melting and/or stereolithography and/or fused deposition modeling and/or cold spraying.

10. The method according to claim 1, wherein the basic structure and the supporting structure are manufactured from the same material or from materials of similar type or from materials of dissimilar type, in particular of different aluminum alloys.

11. The method according to claim 1, wherein the material of the basic structure is more resistant to a specific material, in particular mercury, than the material of the supporting structure and/or wherein the material of the supporting structure has a higher strength than the material of the basic structure.

12. The method according to claim 1, wherein the basic structure of the component is manufactured by means of a non-additive primary forming method, in particular casting or pressing, and/or by means of a non-additive forming method, in particular bending or rolling, and/or by means of a non-additive joining method, in particular welding, soldering or gluing, and/or by means of a non-additive separation method, in particular machining or cutting.

13. The method according to claim 1, wherein the component is a component for a technical device, in particular a component for a pressure vessel, in particular a pressure vessel wall, a pressure vessel lid, a pressure vessel base or a pipeline, or a component through which fluid flows for a heat exchanger, in particular a partition plate, a lamella, a cover plate, an edge strip, a distributor or a pipeline.

14. A component manufactured in part additively for a technical device, manufactured according to the method according to claim 1.

15. The component according to claim 14 manufactured in part additively, designed as a component for a pressure vessel, in particular as a pressure vessel wall, a pressure vessel lid, a pressure vessel base or a pipeline, or as a component through which fluid flows for a heat exchanger, in particular as a partition plate, a lamella, a cover plate, an edge strip, a distributor or a pipeline.
